(19) United States
(12) Patent Application Publication
(10) Pub. No.: US 2002/0129229 A1
(43) Pub. Date: Sep. 12, 2002

(54) Microinstruction sequencer stack

(76) Inventors: Michael Cornaby, Hillsboro, OR (US); Benjamin Chaffin, Portland, OR (US); Lawrence O., III Smith, Beaverton, OR (US)

Correspondence Address: KENYON & KENYON, Suite 700, 1500 K Street, NW, Washington, DC, 20005-1257, US

(21) Appl. No.: 09/750,093

(22) Filed: Dec. 29, 2000

(51) Int. Cl. G06F 9/42

(52) U.S. Cl. 712/245; 712/228

(57) ABSTRACT

The use of a stack, in a microinstruction sequencer of a microprocessor, to redirect a sequence of microinstructions or to provide parameter passing is disclosed. In an embodiment the microinstruction sequencer stack comprises an array of memory cells and control logic and is coupled to receive data and control values from microinstruction sequencing logic and/or the microprocessor core. In another embodiment in accordance with the invention, a microprocessor includes a microinstruction sequencer including an array of memory cells dedicated to the microinstruction sequencer, an address multiplexer coupled to the array of memory cells, sequencing logic coupled to the address multiplexer and to the array of memory cells, and a microprocessor core unit coupled to the array of memory cells. In an embodiment for a method of the invention, a method of directing the sequence of execution of microinstructions during a call to and return from a subroutine includes receiving a microinstruction at a microinstruction sequencing logic, pushing a value in a field of the microinstruction onto a microinstruction sequencer stack, executing the subroutine, popping the value from the microinstruction sequencer stack to a microinstruction address multiplexer, and returning to the return address of the subroutine by sequencing the value from the address multiplexer to a microinstruction sequencer.

### FIELD OF THE INVENTION

The invention relates to operations in a microprocessor, and more specifically, to the use of a stack, in a microinstruction sequencer of a microprocessor, to redirect a sequence of microinstructions or to provide parameter passing.

### BACKGROUND

Data processing operations in a computer are typically carried out in a microprocessor. Generally, the microprocessor, which supervises and implements various data processing tasks for the computer, contains hardware components for processing instructions and data. Instructions together with data are typically stored in a computer memory subsystem, which may include Read Only Memory (ROM), Random Access Memory (RAM), hard disk drives, or other devices. The memory subsystem is typically physically separate from the microprocessor, although copies of instructions and data are temporarily stored on the microprocessor during program execution.

An instruction is a group of bits that tell the computer to perform a specific operation. A part of an instruction is an operation code. The operation code is a group of bits that specify an operation to be performed by the microprocessor. For example, operations such as adding, or subtracting, or loading a value from memory, or storing a value to memory may be specified in the operation code. The remainder of the instruction typically provides related parameters for the operation, for example, a register address for add or subtract operations, or a memory address for load or store operations. The set of instructions (and thereby operations) formulated for a computer depends on the processing it is intended to carry out.

An operation is distinguishable from a micro-operation. An operation is specified by an instruction stored in computer memory. The instruction may be retrieved from memory and interpreted to determine what operation code bits are contained therein. Depending on the operation code and related parameters, a sequence of microinstructions is issued to perform micro-operations on microprocessor registers. The sequence of micro-operations cause hardware circuits to implement the operation code. For this reason, an operation code is sometimes referred to as a macro-operation, because it specifies a set of micro-operations. As used herein, micro-operations are written in microcode, which may be thought of as the code defining the internal operation of the microprocessor.

Microprocessors typically employ a limited set of registers to store, for example, data that is to be operated upon by the microcode executed by the microprocessor. Because there is a limited set of registers, it is useful to have an organized method of saving and restoring register information. A stack is one such method. Most microprocessors have instructions that natively support stacks, using a portion of the memory subsystem to save register information and a dedicated internal register (stack pointer) to index the register information in the memory subsystem. The term natively, as used herein, indicates that the instruction set of the microprocessor has specific instructions that are designed to work with a stack, as opposed to implementing a stack using combinations of non-stack specific instructions.

Conventional microprocessors, as exemplified by the microarchitecture of an Intel x86 style microprocessor, make limited use of stacks in the internal microarchitecture of the microprocessor. Specifically, there is no known use of a stack in a microprocessor for microinstruction sequencing and related parameter passing.

### BRIEF DESCRIPTION OF THE DRAWINGS

FIG. 1 is a simplified block diagram of a microprocessor in accordance with an embodiment of the invention.

FIG. 2 is a block diagram of a portion of a microinstruction sequencer in accordance with an embodiment of the invention.

FIG. 3A depicts a first generalized microinstruction format.

FIG. 3B depicts a second generalized microinstruction format.

FIG. 4 illustrates the general functional operations that may occur in a pipeline.

### DETAILED DESCRIPTION OF AN EMBODIMENT OF THE INVENTION

An embodiment of the invention includes a stack, i.e., a storage area, with associated hardware and microcode as needed to read from and write to the stack. The stack may be located in the internal microarchitecture of a microprocessor. The stack may be used to store microinstruction addresses for redirecting execution of a sequence of microinstructions. It may also be used for related parameter passing between sequences of microinstructions. The stack is hereinafter referred to as a Microinstruction Sequencer (MS) stack. In one embodiment, the MS stack may be a dedicated array of memory cells and associated control logic within the physical microarchitecture of a microinstruction sequencer in a microprocessor. Use of a microarchitecture that includes the MS stack improves throughput speed and resource utilization of the microprocessor at least by: reducing the number of registers required to execute a microinstruction sequence; eliminating the time delay associated with the assignment, transmission, and retrieval of data from registers; and reducing the number of microinstructions executed by a program.

Note that the memory cells refer to an internal microarchitectural structure and need not be physically connected to the computer memory subsystem or the portion of the microprocessor that contains data and instructions from the computer memory subsystem. The MS stack may be a data stack, where the data may include microinstruction addresses and parameters for related parameter passing. The dedicated array of memory cells may be in the form of static random access memory (SRAM) cells. While SRAM cells are used in one embodiment, other types of cells, such as DRAM or Flash may also be used to implement a stack within the microprocessor.

The MS stack may receive control values and data from, and may send data to, other units within the microprocessor, such as a microinstruction sequencer address multiplexer (hereinafter “address multiplexer or address MUX”), microinstruction sequencing logic (hereinafter “sequencing logic”), microinstruction immediate logic (hereinafter “immediate logic”), or the execution/retirement core of the microprocessor (hereinafter “core” or “core unit”). As used in this application, “logic” may include hardware logic, such as circuits that are wired to perform operations. As used in this application, “sequencing logic” may include hardware designed to present a microinstruction or microinstructions to a subsequent processing stage in a microprocessor in an order and with a timing as is appropriate for the microprocessor. As used in this application, “immediate logic” may include hardware designed to manipulate the immediate field of microinstructions for presentation to a subsequent processing stage in a microprocessor. As used in this application the functionality of a microprocessor may be implemented with hardware on a single die within a single package, or on multiple physically separate die in a single package or in multiple physically separate packages.

Control values to the MS stack may be generated by the hardware in the sequencing logic based on microinstruction decode. Control values may also be generated by the execution and retirement logic within the execution unit and retire unit, respectively. Control of the MS stack may be implemented with newly formulated microinstructions.

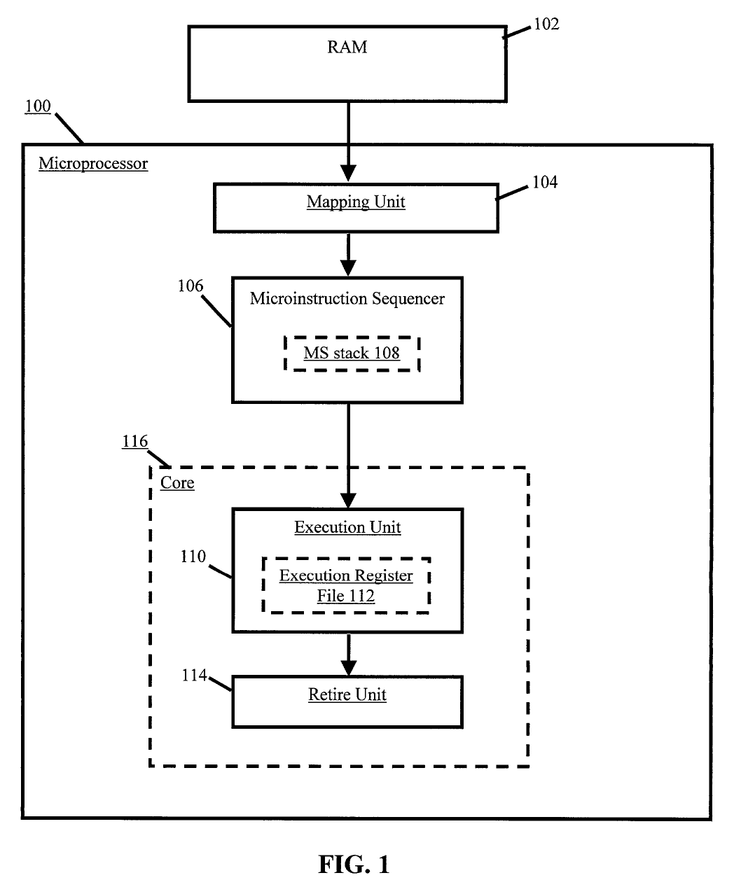

FIG. 1 is a simplified block diagram of a microprocessor 100 having an interface to a random access memory (RAM or memory) 102. FIG. 1 illustrates, in a broad manner, the location of the MS stack 108 within the microarchitecture of the microprocessor 100.

RAM 102 stores macroinstruction code. Macroinstruction code may be passed to the microprocessor 100, which performs operations on data in accordance with the instructions in the macroinstruction code. Within the microprocessor, macroinstructions are mapped to microinstructions by a mapping unit 104. Pointers to microinstruction sequences are then passed from the mapping unit 104 to a microinstruction sequencer 106. In an embodiment, the MS stack 108 is physically located within the microinstruction sequencer 106. Microinstructions are sequenced from the microinstruction sequencers 106 to the core 116 of the microprocessor 100. Each microinstruction is executed in an execution unit 110. During execution of a program, the microprocessor 100 has access to the MS stack 108, conventional flat Execution Register File 112 space (also located within the microprocessor 100), and RAM 102. The microprocessor 100 may modify the MS stack 108, flat Execution Register File 112 space, and RAM 102 in accordance with macro and microinstructions sequencing through the microprocessor 100. At retire unit 114, the microprocessor 100 ensures that all changes made to the MS stack 104, flat Execution Register File 112 space, and RAM 102 are correct. If changes are correct, these changes are then committed to the system state.

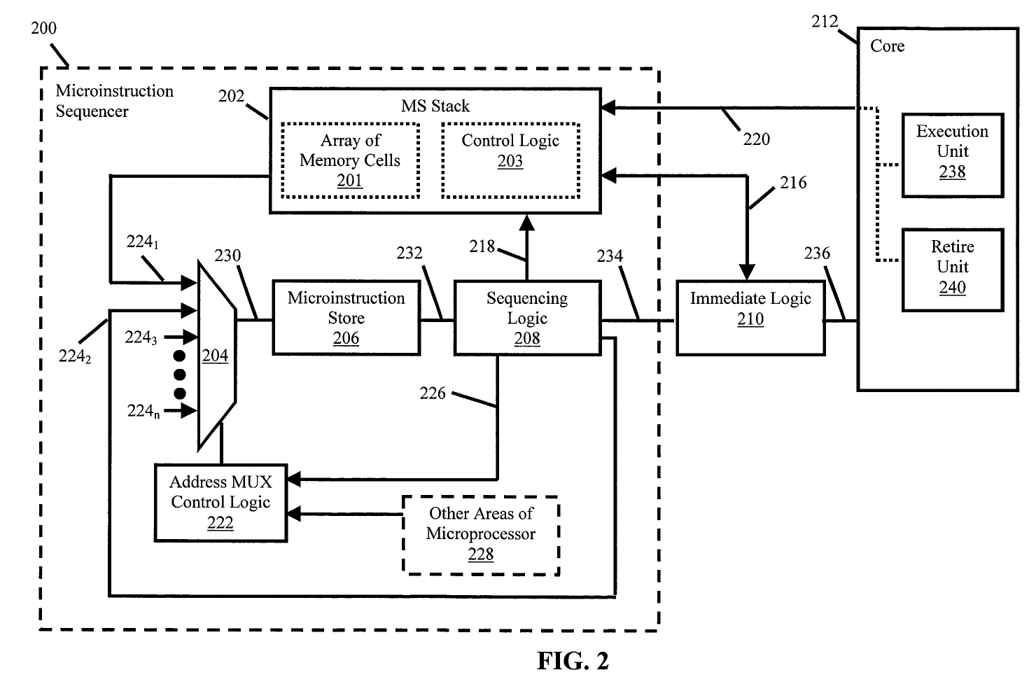

FIG. 2 is a block diagram of a portion of a microinstruction sequencer 200 (similar to 106). The microinstruction sequencer 200 of FIG. 2 illustrates the interconnection of an MS stack 202 with various other components of a microprocessor. As illustrated in FIG. 2, the MS stack 202 may include an array of memory cells 201 and control logic 203. The MS stack 202 may communicate with an address MUX 204, sequencing logic 208, immediate logic 210, and the microprocessor core 212. The MS stack 202 may provide data, generally microinstruction addresses, to the address MUX 204 via input address line 224₁. The MS stack 202 may also send data to and receive data from immediate logic 210 via interconnection 216. Sequencing logic 208 may provide control values and data to the MS stack 202 via interconnection 218. Data may be passed to the microprocessor core 212 from immediate logic 210 via interconnect 236. Of course, the functionality of sequencing logic 208 and immediate logic 210 may be combined into one unit without departing from the scope of the invention.

Control and data lines 220 interconnect the microprocessor core 212 and the MS stack 202. As illustrated in FIG. 2, both the execution unit 238 and the retire unit 240 may communicate with the MS stack 202 via control and data lines 220. Control and data lines 220 allow, for example, for situations in which the microprocessor core 212 may want to push values onto the MS stack 202. For example, event processing logic (not shown) in the core 212 of the microprocessor 200, saves information relevant to events and determines the correct event, if any, that the microprocessor 200 should act upon. An event, in general, is a condition at retire unit 240 that is an unpredicted occurrence necessitating that the results of microinstructions yet to be committed to system state be discarded. An “assist” is an example of an event.

The address MUX 204 receives input address lines 224₁, 224₂, 224₃, . . . , 224ₙ from various locations in the microprocessor, including but not limited to the MS stack 202, sequencing logic 208, and the mapping function 104 (FIG. 1). The address MUX 204 selects from among its input address lines 224₁, 224₂, 224₃, . . . , 224ₙ in order to pass the address of a microinstruction to the microinstruction store 206.

Selection of the address MUX input address lines 224₁, 224₂, 224₃, . . . , 224ₙ is accomplished via address MUX control logic 222. Control logic 222 may accept inputs from sequencing logic 208 via interconnection 226, as well as from other areas 228 of the microprocessor (not described herein, but represented by dashed block and dashed arrow in FIG. 2). An example of an input from other areas 228 of the microprocessor may be a global reset signal line, activated by a global reset vector on the processor.

Each of the possible input address lines 224₁, 224₂, 224₃, . . . , 224ₙ to the address MUX 204 are prioritized with respect to each other within the control logic 222. The control logic 222 may be conceptualized as a prioritization function, which selects the highest priority input address line 224₁, 224₂, 224₃, . . . , 224ₙ presented to the address MUX 204 for multiplexing to the microinstruction store 206. Once the input address line 224₁, 224₂, 224₃, . . . , 224ₙ is selected by the control logic 222, the address is applied to the microinstruction store 206 via interconnection 230.

Microinstruction store 206 contains a plurality of the microinstruction sequences used in the microprocessor 100 (FIG. 1), however, in an embodiment, it need not contain all of the microinstruction sequences used in the microprocessor 100.

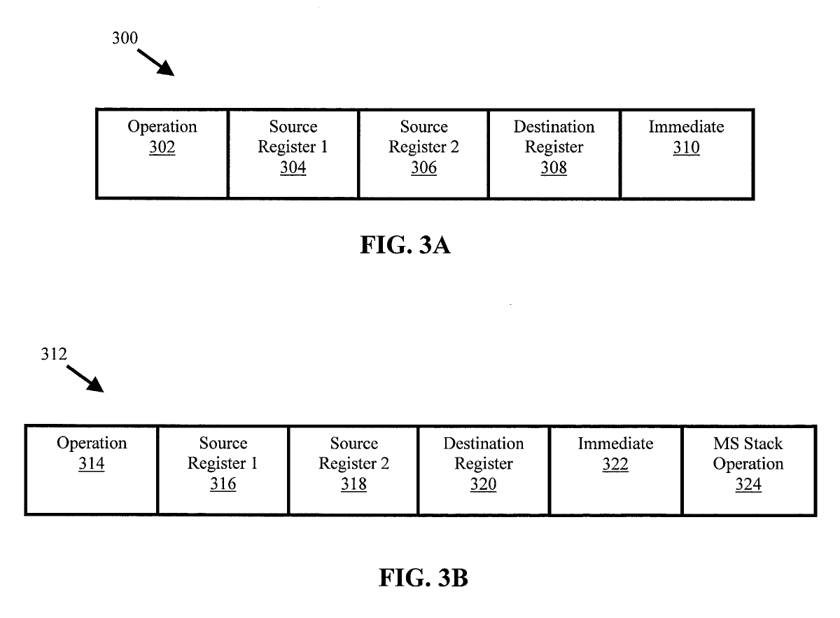

Microinstructions from the microinstruction store 206 are passed to the sequencing logic 208 via interconnection 232. The sequencing logic 208 determines if there are any microinstructions being issued which affect the MS stack 202. There are at least two methods that could be used to determine if a microinstruction affects the MS stack 202. FIG. 3A depicts an abstract microinstruction 300 having five encoding fields: Operation 302, Source Register 1 304, Source Register 2 306, Destination Register 308, and Immediate 310. Operations encodings used to populate the operation field 302 may be defined for each of the possible actions that could affect the MS stack. Examples of such actions are given below in the section entitled “MS Stack Microinstructions.” In an embodiment, the portions of the processor not concerned with the microinstruction sequencer using an MS stack, may treat these microinstructions as non-operations (NOPs). The second method may be to add a new field to the microinstruction. FIG. 3B depicts an abstract microinstruction 312 having six encoding fields: Operation 314, Source Register 1 316, Source Register 2 318, Destination Register 320, Immediate 322, and MS Stack Operation 324. This microinstruction would allow encodings used to populate the MS Stack Operation 324 field to be performed in the microinstruction sequencer 200, while still allowing the rest of the processor the possibility of doing something different. For example, MS stack operations may require the use of both the Immediate 322 field and the MS Stack Operation 324 field. In such instance, the Operation 314, Source Registers 316, 318, and Destination Register 320 fields could be used to, for example, encode an add of two registers. Of course, many other operations and variations could be accomplished using these fields.

The sequencing logic 208 may send the MS stack 202 data and commands via interconnection 218. Additionally, sequencing logic 208 may be performing tasks in addition to those just described. Sequencing logic 208, may, for example, determine the incremental address. It also may determine if there are stall conditions that would prevent it from issuing any or all of the set of the microinstructions to further stages in a microprocessor pipeline.

Sequencing logic 208 passes microinstructions to immediate logic 210 via interconnect 234. The immediate logic 210 maintains the immediate field in each microinstruction. The immediate field as stored in the microinstruction store 206 could be a simple piece of data. It also could be a pointer to a piece of data contained in the processor at a later stage in a pipeline. It could also be a combination of data and an operation to be performed on the data. Other examples of the immediate field are possible and the preceding examples are not meant to be limiting. The immediate logic 210 determines what, if anything, needs to be done with the immediate field. The immediate logic 210 decodes microinstructions and puts the correct value in the immediate fields of the microinstructions. This field may be an input to or an output from the MS stack 202. An immediate field may include a microinstruction address. Therefore, the immediate logic 210 may have a value that is sent back to the address MUX 204, via the MS stack 202. Input and output between the MS stack 202 and the immediate logic 210 is transferred on interconnection 216. Data sequencing on interconnection 216 may be, for example, data from the MS stack or data from the immediate field of a microinstruction.

The processor core 212 also can supply control and data to the MS stack via control and data lines 220. After the immediate logic 210, microinstructions are sent, via bus 236, to the next pipeline stage in the processor core 212. The processor core includes execution unit 238 and retire unit 240, both of which may communicate with the MS stack 202 via control and data lines 220.

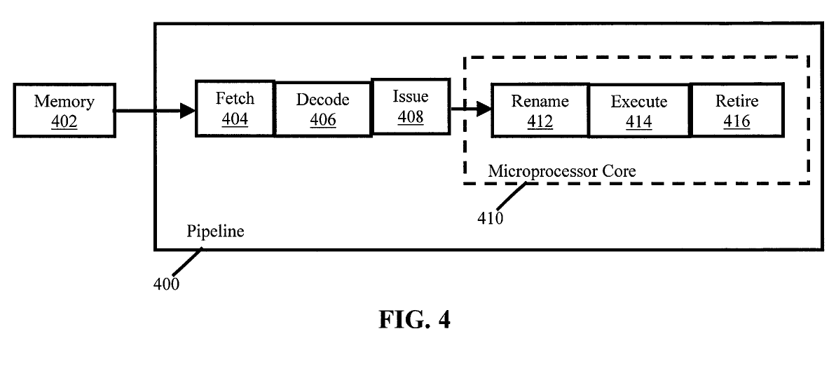

FIG. 4 illustrates general functional operations that may occur in a pipeline. The illustration of FIG. 4 is not meant to be limiting. The pipeline 400 of FIG. 4 includes six stages. In general, input applied to a first stage is processed in accordance with the function of that stage and then an appropriate output is passed to the next stage. Processing may include data storage or data manipulation. The first stage, Fetch 404, obtains macroinstructions from memory subsystem 402. Memory subsystem 402 may be, for example, RAM. The second stage, Decode 406, maps the macroinstruction bytes to microprocessor specific microinstructions. The Issue 408 stage sequences the microinstructions to the microprocessor core 410. In an embodiment, the MS stack 202 (FIG. 2), 108 (FIG. 1) is utilized in the Issue 408 stage. The microprocessor core 410 may include hardware configured to perform the functions of, for example, renaming, scheduling, arithmetic operations (as in an Arithmetic Logic Unit (ALU)), memory accesses, and retirement. In the microprocessor core, the Rename 412 stage allocates processor resources and maps logical sources and destinations to physical sources and destinations. The Execute 414 stage executes microinstructions. The Retire 416 stage ensures that the microinstructions were executed correctly and commits microinstruction changes to processor state. Note that the illustration of FIG. 4 depicts a simplified pipeline for illustration purposes only. Microprocessors with forty or more pipeline stages are common.

### MS Stack Microinstructions

There are at least seven microinstructions that may be used to control the MS stack 202 (FIG. 2): ms_call, ms_return, ms_push, ms_pop, ms_uip_stack_clear, ms_tos_read, and ms_exec_push. Other microinstructions may also be used. As used herein, the prefix “ms” stands for microinstruction sequencer. These microinstructions define an interface between microcode and the MS stack 202. The microinstructions define what the hardware of the processor does. Each of the at least seven microinstructions mentioned above are now described below.

| | |
|---|---|
| ms_call- | The sequencing logic 208 instructs the MS stack |
| | 202 to push the address of the next microinstruc- |
| | tion after the ms_call. For example, this address |
| | may be the address of the ms_call plus one. |
| | Therefore, in an embodiment, when an ms_call |
| | microinstruction is decoded, the sequencing logic |
| | 208 may generate the microinstruction address of |
| | the ms_call, add an intermediary value to it, |
| | which in this example is one, and send the |
| | resultant value to the MS stack 202. It may also |
| | send control values to the MS stack 202 indica- |
| | ting that the incremented microinstruction address |
| | is to be pushed on the MS stack 202. Data and |
| | control may be sent from sequencing logic 208 to |
| | MS stack 202 via interconnection 218. |
| | Furthermore, the value in the immediate field of |
| | the microinstruction may be sent to the address |
| | MUX 204 via, for example, input address line |
| | 224₂. Control values may be sent from the |
| | sequencing logic 208 to the address MUX control |
| | logic 222 via control line 226. The control values |
| | instruct the address MUX control logic 222 to |
| | select the address MUX input corresponding to |
| | the immediate field input, which in this example |
| | is input address line 224₂. Thus, in this example, |
| | the ms_call microinstruction has redirected the |
| | sequence of execution of microinstructions. |
| ms_return- | The sequencing logic 208 instructs the MS stack |
| | 202 to pop and send the popped value to the |
| | address MUX 204 and the immediate logic 210; |
| | the immediate logic 210 inserts the value into the |
| | ms_return microinstruction immediate field and |
| | passes it to the core 212. Passing the value to |
| | immediate logic 210 may be useful for debugging |
| | and other functional aspects such as creation of |
| | data dependencies. Additionally it may be used as |
| | an input to path-dependent branch conditions. The |
| | ms_return microinstruction also redirects the |
| | sequence of execution (the next address fetched |
| | will come from the MS stack 202 through the |
| | address MUX 204, so use of ms_return changes |
| | the microinstructions that would be issued had not |
| | the MS stack 202 been used). |
| ms_push- | The sequencing logic 208 instructs the MS stack |
| | 202 to push the value in the immediate field of |
| | the microinstruction onto the MS stack 202. This |
| | value comes from the immediate logic 210. The |
| | ms_push microinstruction does not send a value |
| | to the address MUX 204. |
| ms_uip_stack_clear- | The sequencing logic 208 instructs the MS stack |
| | 202 to return to a reset state. The reset state is |
| | typically hard-coded in logic. So for example, if |
| | the processor must be reset, then the processor |
| | can restart from a known state. The ms_uip_{—} |
| | stack_clear microinstruction does not send a |
| | value to the address MUX 204. There are cases |
| | where a microinstruction sequence should be |
| | completely aborted. In this case, the ms_uip_{—} |
| | stack_clear microinstruction may be used to |
| | completely clear the stack. The ms_uip_{—} |
| | stack_clear microinstruction may be executed by |
| | microcode, as in the case of, for example only, |
| | clearing the MS stack because of the need to abort |
| | a macroinstruction for event-related conditions. In |
| | such a case, the hardware may not have enough |
| | information to know when to clear the MS stack |
| | appropriately. |
| ms_pop- | The sequencing logic 208 instructs the MS stack |
| | 202 to pop and send the popped value to the |
| | immediate logic 210. The immediate logic 210 |
| | takes the value and puts it in the immediate field |
| | of the microinstruction. The ms_pop micro- |
| | instruction does not send a value to the address |
| | MUX 204. |
| ms_tos_read- | The sequencing logic 208 instructs the MS stack |
| | 202 to send the value it would pop to the |
| | immediate logic 210, without actually popping. |
| | The immediate logic 210 puts that value in the |
| | immediate field of the microinstruction. The ms_{—} |
| | tos_read microinstruction does not send a value |
| | to the address MUX 204. |

In debugging problems in pre-production parts, it may be useful to read
the contents of the MS stack. This can be accomplished with the ms_pop
and ms_tos_read microinstructions. The ms_tos_read is non-intrusive.
It does not affect the contents of the stack. The ms_pop will affect the
contents of the stack.

| | |
|---|---|
| ms_exec_push- | The ms_exec_push microinstruction does not |
| | affect the MS stack 202 when it is sequenced |
| | through sequencing logic 208 or when it is |
| | sequenced through immediate logic 210. When |
| | the ms_exec_push microinstruction reaches the |
| | appropriate execution unit 238, it reads out a |
| | register and sends the contents back to the MS |
| | stack 202 along with the appropriate control |
| | values for the MS stack 202 to push the value. |
| | Control values and register contents may be |
| | communicated to the MS stack 202 via control |
| | and data lines 220. The ms_exec_push |
| | microinstruction may be used to place a computed |
| | value onto the MS stack 202 from the execution |
| | unit 238 of the core 212. |

### Flat-Registers Compared To MS Stack Implementation

The use of an MS stack-based space may be an improvement over the use of a conventional model of flat register-based space as the following four example sets illustrate. Note that the example sets are discussed with reference to the figures and reference numerals contained herein, however, such use is not meant to be limiting. Each example set consists of a pseudocode sequence of microcode for a conventional microarchitecture, followed by a comparable pseudocode sequence of microcode for a microarchitecture implementing an MS stack.

### EXAMPLE SET ONE

Assume the following pseudocode sequence of microcode for a conventional flat register-based space as typified by an Intel x86 microarchitecture:

.
.
.
tmp_reg = address(SUBROUTINE_A_RETURN_POINT)
Jump to SUBROUTINE_A

SUBROUTINE_A_RETURN_POINT:

.
.
.

SUBROUTINE_A:

.
.
.
jump to the address in tmp_reg

In the flat register-based space (a microarchitecture not employing an MS stack), the following steps may be required for a subroutine call and return:

1. The return address is placed in the immediate field of a microinstruction.

2. The microinstruction with the return address is issued from a microinstruction sequencer.

3. The return address microinstruction proceeds down a pipeline until it reaches the execution stage where the result is written into an Execution Register File 112. At this point, the return address is written to the Execution Register File 112.

4. After all of the other microinstructions in the subroutine have been issued, the final microinstruction is an indirect branch to the contents of a register in the Execution Register File 112. This register is the one containing the return address. This indirect branch is issued from the microinstruction sequencer. At this point, the microinstruction sequencer typically may stall (temporarily stop sequencing microinstructions), because it does not have information regarding the next microinstruction to issue. Note that this stall also causes a time penalty in that it prevents the microinstructions after the subroutine call from issuing into the machine.

5. The indirect branch proceeds down the pipeline until it reaches the point where the Execution Register File 112 is read. Here it reads the return address.

6. At a subsequent pipestage, the indirect branch sends the return address to the microinstruction sequencer, along with control values, which cause the microinstruction sequencer to start sequencing microcode at the return address.

If the simplistic pipeline of FIG. 4 is used as a reference, it will take two pipestage delays to get the return address into the Execution Register File. It will take an additional two pipestage delays for the indirect branch to read the Execution Register File and another two pipestage delays for the indirect branch to get the return address back to the microinstruction sequencer. Thus, there is a time penalty of six pipestage delays for this simplistic pipeline in a flat register space.

Below is a similar pseudocode sequence of microcode for a microarchitecture employing an MS stack 202 within the microinstruction sequencer 106, 200.

.
.
.
ms_call SUBROUTINE_A

SUBROUTINE_A_RETURN_POINT:

.
.
.

SUBROUTINE_A:

.
.
.
ms_return

When the ms_call is sequenced, the value of the ms_call microinstruction address plus one is pushed to the MS stack 202, which happens to be identically SUBROUTINE_A_RETURN_POINT. Also, the ms_call sends the address SUBROUTINE_A to the address MUX 204, and the address MUX control logic 222 selects the address that comes from the MS stack 202. By selecting the address that comes from MS stack 202, the next microinstruction to be sequenced after the ms_call will be the microinstruction at SUBROUTINE_A. Therefore, the microinstructions beginning with the address of SUBROUTINE_A and ending with the address of ms_return will be issued. When the ms_return microinstruction is reached, the sequencing logic 208 instructs the MS stack 202 to pop and send the value to the address MUX 204. Thus, the next microinstruction to be sequenced will be the address at the top of the stack, which in this case was SUBROUTINE_A_RETURN_POINT, or the ms_call microinstruction address plus one.

Recall from the description of ms_return, above, that upon sequencing an ms_return the sequencing logic 208 instructs the MS stack 202 to pop and send the value to both the address MUX 204 and the immediate logic 210. The value may be sent to the immediate logic 210 because one might be interested in the values that were popped from the MS stack, and one might want to put that value in a register in the Execution Register File 112. Sending this value to the immediate logic 210 may also be desired for debugging and for other functional aspects, such as providing a data dependency, or as an input to path-dependent branch conditions.

Returning to FIG. 1, note that in an MS stack implementation, the storage of the return point of a subroutine in Execution Register File 112 is not required as it was when temp_reg was used in the conventional flat-register model. The storage of the return point of the subroutine in Execution Register File 112 is not required because the return point is pushed onto the MS stack 108, which is physically collocated with the microinstruction sequencer 106. Therefore, there are no pipestage delays in the microarchitecture employing the MS stack 108. Also note that the time delay required to fetch and subsequently execute the microinstruction required to reserve the register 112 is eliminated because the address where the next microinstruction will sequence from after SUBROUTINE_A is already in the MS stack 108. Furthermore, because the MS stack 108 is physically within the microinstruction sequencer 106, which is within the Issue 408 (FIG. 4) pipeline stage, there is no communication required to transfer the contents of temp_reg to the Issue 408 pipeline stage, and thus no stall required while the processor waits for the contents of the temp_reg to be transferred. Therefore, use of the MS stack 108 avoids the communication delay inherent in conventional flat-register based microinstruction programming models.

For a microarchitecture implementing an MS stack 108, the following steps may be required for a subroutine call and return:

1. The ms_call microinstruction is issued from the microinstruction sequencer 106. No information is required to be written to the Execution Register File 112, because the return address has been written to the MS stack 108.

2. The subroutine microinstructions are issued from the microinstruction sequencer 106.

3. The last subroutine microinstruction is an ms_return. The return value pushed by the ms_call microinstruction is read from the MS stack 108.

For this simplified example, microinstructions after the subroutine call are issued from the microinstruction sequencer six pipestage delays earlier than in a comparable microarchitecture not using the MS stack. Also note that most microprocessors have many more pipeline stages, so the number of pipestage delays would be much greater than six in practice.

### EXAMPLE SET TWO

The previous example involved a subroutine whose return point was the address of the subroutine call plus one. The following example set involves a subroutine whose return point can be any address in the microcode. For conventional flat register-based space implementation, the pseudocode sequence may appear as follows:

.
.
.
tmp_reg = address(SUBROUTINE_B_RETURN_POINT)
Jump SUBROUTINE_B
.
.
.

SUBROUTINE_B_RETURN_POINT:

.
.
.

SUBROUTINE_B:

.
.
.
jump to the address of tmp_reg

For an MS stack microarchitecture implementation, this pseudocode sequence may be replaced by:

.
.
.
ms_push address(SUBROUTINE_B_RETURN_POINT)
Jump SUBROUTINE_B
.
.
.

SUBROUTINE_B_RETURN_POINT:

.
.
.

SUBROUTINE_B:

.
.
.
ms_return

Because the return microinstruction address is not the call address plus one, the ms_push command is utilized to push the desired return address to the MS stack 202. The ms_return microinstruction, at the bottom of the called subroutine, performs the same operations as have been previously explained.

Comparing Example Sets One and Two, note that the conventional flat register-based case of Example One used one register and two microinstructions, while the MS stack implementation of that case used no registers and only a single microinstruction. Thus, a savings of one register and the associated costs of using that register, along with the savings of the execution of a second microinstruction were realized when the MS stack model was used.

In Example Set Two the conventional flat register-based case used one register and two microinstructions, while the MS stack implementation used no registers but continued to use two microinstructions. While there is no net savings in the number of microinstructions executed, there was a savings in the elimination of a register and the associated resource and time costs in using the register.

### EXAMPLE SET THREE

A third example relates to a condition known as an assist on a conventional Intel style x86 microarchitecture. An assist condition requires that all of the work done by the microinstruction causing the assist and all following microinstructions be discarded to handle a problem affecting that microinstruction. After the problem affecting that microinstruction is resolved, the microinstruction sequence is restarted at that microinstruction and work continues. In cases like this, the processor saves the microinstruction address of the microinstruction that caused the assist. Referring to FIG. 1, on conventional machines, this address is not saved near the microinstruction sequencer 106. Instead, it is stored in another location on the processor, for example, it may be stored in the retire unit 114. Typically, a microinstruction is issued to get the address into the Execution Register File 112. Another microinstruction (e.g., an indirect branch) is used to get the address from the Execution Register File 112 back to the microinstruction sequencer 106. This sequence of events results in a time delay, which can be reduced or eliminated in a microarchitecture implementing an MS stack 108. In a microarchitecture implementing an MS stack 108, the microinstruction address of the microinstruction that caused the assist can be pushed onto the MS stack 108 by the core 116. Because the address is now in the MS stack 108, within the microinstruction sequencer 106, time delay is avoided. The following microinstruction pseudocode sequence for a conventional processor illustrates the use of a single register and two microinstructions required to effect an assist return:

.
.
.
temp_reg = get_the_assist_address
jump to tmp_reg

However, on machines implementing an MS stack, only one microinstruction is required to effect an assist return, as the code below illustrates:

.
.
.
ms_return

Note again that a register is saved and the time delay associated with jumping to a register is eliminated.

### EXAMPLE SET FOUR

It is possible to pass parameters to subroutines or across subroutines using an MS stack. Consider the following microinstruction pseudocode sequence for a conventional processor:

tmp_reg = value
tmp_reg2 = value2
tmp_reg3 = address(RETURN_FROM_SUBROUTINE)
jump to SUBROUTINE_A

RETURN_FROM_SUBROUTINE:

.
.
.

SUBROUTINE_A:

compare tmp_reg, value
jump if not equal to SUBROUTINE_A_PART1
.
.
.
jump to the address in tmp_reg3

SUBROUTINE_A_PART1:

compare tmp_reg2, value2
jump if not equal to SUBROUTINE_A_PART2
.
.
.
jump to the address in tmp_reg3

SUBROUTINE_A_PART2:

.
.
.
jump to the address in tmp_reg3

Note that three parameters are passed to SUBROUTINE_A, requiring three registers. Now compare the above pseudocode with the following pseudocode sequence for a microarchitecture implementing an MS stack:

ms_push address(RETURN_FROM_SUBROUTINE)
ms_push value2
ms_push value
jump SUBROUTINE_A

RETURN_FROM_SUBROUTINE:

.
.
.

SUBROUTINE_A:

tmp_reg = ms_pop
compare tmp_reg, value
jump if not equal to SUBROUTINE_A_PART1
.
.
.
ms_pop
ms_return

SUBROUTINE_A_PART1:

tmp_reg = ms_pop
compare tmp_reg, value2
jump if not equal to SUBROUTINE_A_PART2
.
.
.
ms_return

SUBROUTINE_A_PART2:

.
.
.
ms_return

Note that in the example of parameter passing above implemented with an MS stack 108, the number of registers required to be reserved for passing parameters to subroutines drops from three to zero. A register may be used to get the parameters from the MS stack 108 to the subroutine, but registers need not be required across the subroutine interface.

The disclosed embodiments are illustrative of the various ways in which the present invention may be practiced. Other embodiments can be implemented by those skilled in the art without departing from the spirit and scope of the present invention.

What is claimed is:

1. A microinstruction sequencer including a microinstruction sequencer stack comprising an array of memory cells and control logic, said microinstruction sequencer stack coupled to receive data and control values from one of a microinstruction sequencing logic and a microprocessor core unit.

2. The microinstruction sequencer of claim 1, wherein the microprocessor core unit is an execution unit.

3. The microinstruction sequencer of claim 1, wherein the microprocessor core unit is a retire unit.

4. The microinstruction sequencer of claim 1, wherein the microinstruction sequencing logic includes logic to:
generate a value of a microinstruction address;
add an intermediary value to the value of the microinstruction address to yield an incremented value;
send a control value to the microinstruction sequencer stack, said control value to cause the incremented value to be pushed onto the microinstruction sequencer stack; and
push the incremented value onto the microinstruction sequencer stack.

5. The microinstruction sequencer of claim 1, wherein the microinstruction sequencing logic includes logic to:
send a control value to the microinstruction sequencer stack, said control value to:
cause the microinstruction sequencer stack to pop a value; and
send the popped value to a microinstruction address multiplexer.

6. The microinstruction sequencer of claim 1, wherein the microinstruction sequencing logic includes logic to:
send a control value to the microinstruction sequencer stack, said control value to:
cause the microinstruction sequencer stack to pop a value; and
send the popped value to an immediate logic, said immediate logic to pass the value to the microinstruction core unit.

7. The microinstruction sequencer of claim 1, wherein the microinstruction sequencing logic includes logic to send a control value to the microinstruction sequencer stack, said control value to cause the microinstruction sequencer stack to push a value in an immediate field of a microinstruction onto the microinstruction sequencer stack.

8. The microinstruction sequencer of claim 1, wherein the microinstruction sequencing logic includes logic to send a control value to the microinstruction sequencer stack, said control value to cause the microinstruction sequencer stack to return to a reset state.

9. The microinstruction sequencer of claim 1, wherein the microinstruction sequencing logic includes logic to send a control value to the microinstruction sequencer stack, said control value to cause the microinstruction sequencer stack to pop a value and send the popped value to an immediate logic.

10. The microinstruction sequencer of claim 1, wherein the microinstruction sequencing logic includes logic to send a control value to the microinstruction sequencer stack, said control value to cause the microinstruction sequencer stack to send a value at the top of the microinstruction sequencer stack to an immediate logic.

11. A microinstruction sequencer including a microinstruction sequencer stack comprising an array of memory cells and control logic, said microinstruction sequencer stack coupled to receive data and control values from a microprocessor execution unit.

12. The microinstruction sequencer of claim 11, wherein the microprocessor execution unit includes logic to:
read a register value; and
communicate the register value to the microinstruction sequencer stack.

13. A microprocessor including a microinstruction sequencer comprising:
an array of memory cells dedicated to said microinstruction sequencer;
an address multiplexer coupled to said array of memory cells;
sequencing logic coupled to said address multiplexer and to said array of memory cells; and
a microprocessor core unit coupled to said array of memory cells.

14. The microinstruction sequencer of claim 13, wherein the microprocessor core unit is an execution unit.

15. The microinstruction sequencer of claim 13, wherein the microprocessor core unit is a retire unit.

16. A method of directing the sequence of execution of microinstructions during a call to and return from a subroutine, comprising:
receiving a microinstruction at a microinstruction sequencing logic;
pushing a value in a field of the microinstruction onto a microinstruction sequencer stack, the value is a return address of the subroutine;
executing the subroutine;
popping the value from the microinstruction sequencer stack to a microinstruction address multiplexer; and
returning to the return address of the subroutine by sequencing the value from the address multiplexer to a microinstruction sequencer.

17. The method of claim 16, wherein the value is the address of the call of the subroutine plus one.
